(19) United States
(12) Patent Application Publication
(10) Pub. No.: US 2024/0042794 A1
(43) Pub. Date: Feb. 8, 2024

(54) UNIVERSAL ROLLER HOLDER

(71) Applicant: Elmer Dale Dever, Denver, CO (US)

(72) Inventor: Elmer Dale Dever, Denver, CO (US)

(21) Appl. No.: 18/228,966

(22) Filed: Aug. 1, 2023

Related U.S. Application Data
(60) Provisional application No. 63/395,189, filed on Aug. 4, 2022.

(51) Int. Cl. B44D 3/12; B05C 17/02

(52) U.S. Cl. CPC B44D 3/123; B05C 17/0245

(57) ABSTRACT

A device for holding a paint roller may include a pair of parallel hook arms, a plurality of cross bars attached to and extending between the pair of parallel hook arms, a support bracket attached to and extending between first ends of each of the parallel hook arms, and a brace arm attached to and extending between second ends of each of the parallel hook arms. Each hook arm may have a first portion proximate to the first end, a second portion to the second end, and a middle portion extending between the first portion and the second portion, wherein the first portion, the middle portion, and the second portion form a continuous curved hook arm. The middle portion may extend substantially perpendicularly upward from the first portion; and the second portion may extend downward from the middle portion and may have a concave curve.

### RELATED APPLICATION

This application claims priority to provisional patent application U.S. Ser. No. 63/395,189 filed on Aug. 4, 2022, the entire contents of which is herein incorporated by reference.

### BACKGROUND

The embodiments described herein relate generally to paint accessories and, more particularly, to a universal paint roller holder.

When painting, especially on a commercial level, paint rollers are frequently used. When painting, the only area to place a roller to take a brake is in the paint tray, paint bucket, or commercial speed pan. This often results in the roller being partially or fully submerged in paint. However, when the roller is submerged in paint, the inside of the roller fills with paint, causing future paint separation and color distortion. Moreover, it is not safe to move a commercial speed pan and a roller full of 3 to 4 gallons of paint alone.

Therefore, what is needed is a device for firmly, securely, and safely holding a paint roller to prevent the paint roller from being submerged in paint, wherein the device is configured to easily and removably engage with a paint can, speed pan, or other like container.

### SUMMARY

Some embodiments of the present disclosure include a device for holding a paint roller. The device may include a pair of parallel hook arms, a plurality of cross bars attached to and extending between the pair of parallel hook arms, a support bracket attached to and extending between first ends of each of the parallel hook arms, and a brace arm attached to and extending between second ends of each of the parallel hook arms. Each hook arm may have a first portion proximate to the first end, a second portion to the second end, and a middle portion extending between the first portion and the second portion, wherein the first portion, the middle portion, and the second portion form a continuous curved hook arm. The middle portion may extend substantially perpendicularly upward from the first portion; and the second portion may extend downward from the middle portion and may have a concave curve.

### BRIEF DESCRIPTION OF THE FIGURES

The detailed description of some embodiments of the invention is made below with reference to the accompanying figures, wherein like numerals represent corresponding parts of the figures.

FIG. 1 is side perspective view of one embodiment of the present disclosure.

FIG. 2 is a side elevation view of one embodiment of the present disclosure.

FIG. 3 is a perspective view of one embodiment of the present disclosure, shown installed on a speed pan 20.

FIG. 4 is a top perspective view of one embodiment of the present disclosure, shown installed on a speed pan 20.

FIG. 5 is a top perspective view of one embodiment of the present disclosure, shown in use.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

The device of the present disclosure may be used as a universal paint roller holder and may comprise the following elements. This list of possible constituent elements is intended to be exemplary only, and it is not intended that this list be used to limit the device of the present application to just these elements. Persons having ordinary skill in the art relevant to the present disclosure may understand there to be equivalent elements that may be substituted within the present disclosure without changing the essential function or operation of the device.

The various elements of the present disclosure may be related in the following exemplary fashion. It is not intended to limit the scope or nature of the relationships between the various elements, and the following examples are presented as illustrative examples only.

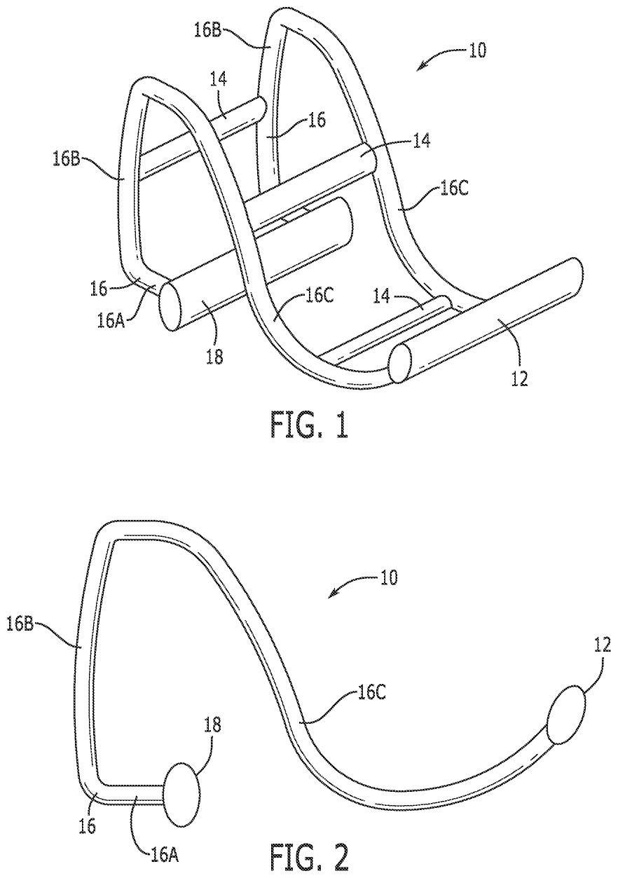

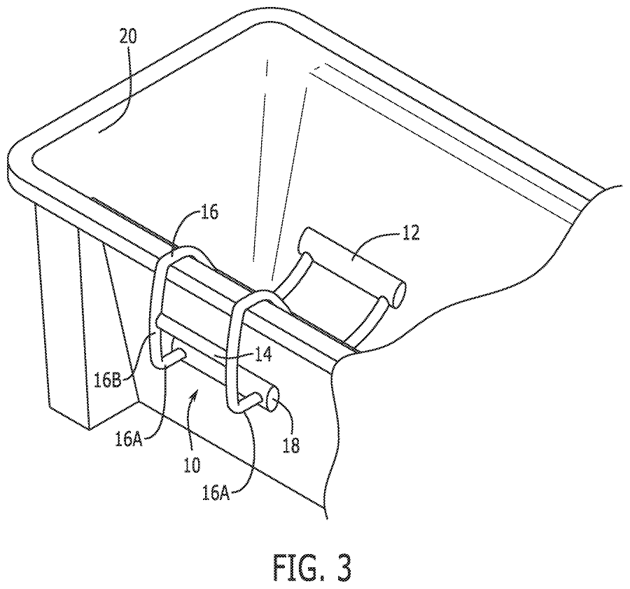

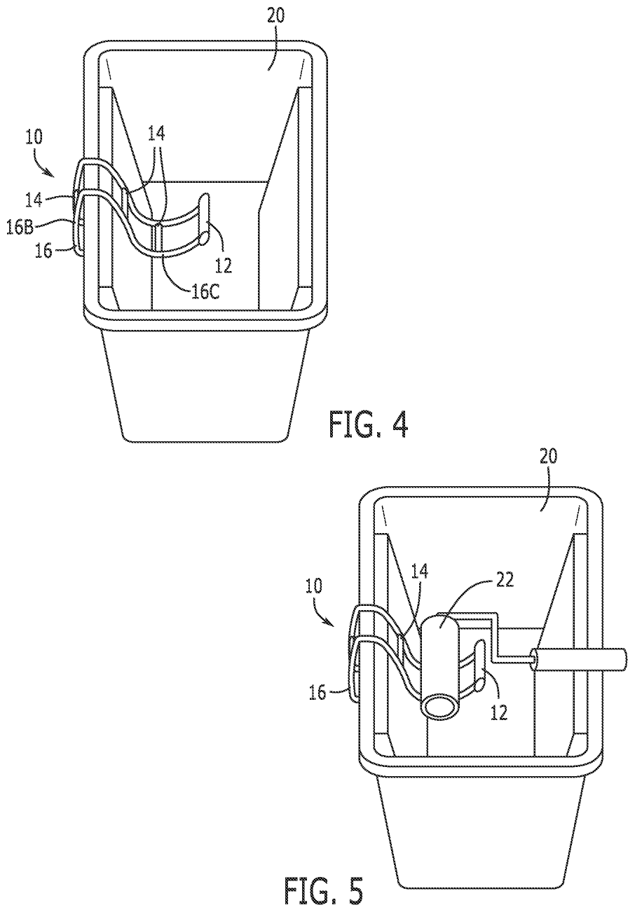

By way of example, and referring to FIGS. 1-5, some embodiments of the present disclosure include a device 10 for holding a paint roller 22, the device 10 comprising a pair of parallel hook arms 16, wherein each hook arm 16 of the pair of parallel hook arms 16 comprises a first end, a second end, a first portion 16A proximate to the first end, a second portion 16C to the second end, and a middle portion 16B extending between the first portion 16A and the second portion 16C, wherein the first portion 16A, the middle portion 16B, and the second portion 16C form a continuous curved hook arm 16; a plurality of cross bars 14 attached to and extending between the pair of parallel hook arms 16; a support bracket bar 18 attached to and extending between the first ends of the pair of parallel hook arms 16; and a brace arm 12 attached to and extending between the second ends of the pair of parallel hook arms 16, wherein the middle portion 16B extends substantially perpendicularly upward from the first portion 16A; and the second portion 16C extends downward from the middle portion 16B and is concavely curved.

As shown in the Figures, the first portion 16A and the middle portion 16B together may form an L-shape, wherein the first portion 16A may be the shorter, bottom portion of the L and the middle portion 16B may be the longer, upright portion of the L. The second portion 16C may continue from the distal end of the middle portion 16B any may first be parallel to the first portion 16A before extending downward into a concave curve. In embodiments, a bottom edge of the concave curve may be substantially in line with the first portion 16A. Furthermore, the free end of the first portion 16A of the hook arm 16 may terminate such that it is spaced apart from the bottom of the concave curve. As shown in FIG. 5, the concavely curved portion of the second portion 16A may be sized to accommodate placement of a roller 22 therein.

As mentioned above, the device 10 may comprise a pair of hook arms 16, wherein the hook arms 16 are positioned parallel to, aligned with, and spaced from one another. A plurality of cross bars 14 may extending between inner surfaces of the hook arms 16, such that the hook arms 16 are attached to one another. In a particular embodiment, the device may comprise three cross bars 14. For example, as shown in FIG. 1, a first cross bar 14 may extend between the first portion 16A of a first hook arm 16 and the first portion 16A of a second hook arm 16. A second cross bar 14 may extend between the downward sloping surface of the second portion 16C of the first hook arm 16 and the downward sloping surface of the second portion 16C of the second hook arm 16, and a third cross bar 14 may extend between the bottom most part of the concave curve on the first hook arm 16 to the bottom most part of the concave curve on the second hook arm 16. As such, the length of each of the cross bars 14 may be equal to the distance between the hook arms 16. As shown in the Figures, each of the cross bars 14 may be a tubular or similarly shaped member.

In embodiments and as mentioned above, a support bracket bar 18 may be connected to and extend across each of the first end of the first hook arm 16 and the first end of the second hook arm 16. As shown in FIGS. 1 and 2, the support bracket bar 18 may extend past each of the first end of the first hook arm 16 and the first end of the second hook arm 16, such that the length of the support bracket bar 18 may be greater than the distance between the first hook arm 16 and the second hook arm 16. As shown in the Figures, a plane of the the support bracket bar 18 may be substantially parallel to a plane of each of the cross bars 14, wherein the support bracket bar 18 may extend substantially perpendicular to an elongate length of the first portion 16A of each of the hook arms 16. In embodiments, the support bracket bar 18 may be a tubular or similarly shaped member. In a particular embodiment, and as shown in FIG. 2, the support bracket bar 18 may have a substantially oval shaped cross-section, wherein a diameter of the support bracket bar 18 may be larger than that of the cross bars 14.

As previously discussed, the device 10 may further comprise a brace arm 12 attached to and extending across each of the second end of the first hook arm 16 and the second end of the second hook arm 16. Similar to the support bracket bar 18, the brace arm 12 may extend past each of the second ends, such that the length of the brace arm 12 is greater than the distance between the first hook arm 16 and the second hook arm 16. As shown in FIG. 2, the brace arm 12 may be positioned such that it extends the upward curve of the concave curve in the second portion 16C of the hook arm 16. The brace arm 12 may be similar in shape to the support bracket bar 18, wherein the brace arm 12 may be a tubular or similarly shaped member. In embodiments, the brace arm 12 may have a substantially oval shaped cross-section, wherein a diameter of the brace arm 12 may be larger than that of the cross bars 14.

The device 10 of the present disclosure may be sized such that the first portion 16A and the middle portion 16B of the hook arm 16 are positioned on the outside of a container, such as a commercial speed pan 20, and the second portion 16C of the hook arm 16 extends over the top of the container rim and down into the interior of the container, wherein the support bracket arm 18 is positioned to abut the outer surface of the side of the container. As such, depending on the thickness of the walls of the container and the overall dimensions of the container and roller 22, the dimensions of the device 10 may vary. The device 10 may be made of any suitable materials and, in some embodiments, may comprise metal or plastic dipped in or sprayed with a rubber compound.

To use the device 10 of the present disclosure, the device 10 may be easily cooked onto the side of the container or speed pan 20. When the user needs to put the paint roller 22 down, he or she may easily and quickly place the roller into the concave curve of the second portion 16C, wherein the brace arm 12 may function as a stop to prevent the roller 22 from rolling out of the device 10. As shown in FIG. 5, the roller 22 may be positioned in the concave curve while the handle may rest on the rim on the opposite side of the speed pan 20, thus preventing the roller 22 from being submerged in the paint in the container. Once the roller 22 is placed in the device 10, the user may safely move the speed pan 20 to another location or area as needed.

The above-described embodiments of the invention are presented for purposes of illustration and not of limitation. While these embodiments of the invention have been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

What is claimed is:

1. A device for holding a paint roller, the device comprising:
a pair of parallel hook arms, wherein:
each hook arm of the pair of parallel hook arms comprises a first end, a second end, a first portion proximate to the first end, a second portion to the second end, and a middle portion extending between the first portion and the second portion; and
the first portion, the middle portion, and the second portion form a continuous curved hook arm; a
a plurality of cross bars attached to and extending between the pair of parallel hook arms;
a support bracket bar attached to and extending between the first end of a first hook arm of the pair of parallel hook arms and the first end of a second hook arm of the pair of parallel hook arms; and
a brace arm attached to and extending between the second end of the first hook arm of the pair of parallel hook arms and the second end of the second hook arm of the pair of hook arms,
wherein:
the middle portion extends substantially perpendicularly upward from the first portion; and
the second portion extends downward from the middle portion and has a concave curve.

2. The device of claim 1, wherein the concave curve is sized to accommodate placement of a roller portion of the paint roller therein.

3. The device of claim 1, wherein:
the first portion and the middle portion together form an L-shape with the first portion being a shorter bottom arm of the L-shape and the middle portion being the longer, upright arm of the L-shape; and
the second portion continues from a distal end of the middle portion; and
the second portion comprises a first length that is parallel to the first portion and a second length that extends downward into the concave curve.

4. The device of claim 1, a bottom edge of the concave curve is substantially in line with the first portion.

5. The device of claim 4, wherein a proximal end of the first portion terminates such that it is spaced apart from the bottom edge of the concave curve.

6. The device of claim 1, wherein each cross bar of the plurality of cross bars extends from an inner surface of the first hook arm of the pair of hook arms to the second hook arm of the pair of hook arms such that a length of each cross bar is equal to the distance between the pair of hook arms.

7. The device of claim 1, wherein each cross bar of the plurality of cross bars is a tubular member

8. The device of claim 1, wherein the support bracket bar has a length larger than a distance between the pair of hook arms.

9. The device of claim 1, wherein the brace arm has a length larger than a distance between the pair of hook arms.
